(19) United States
(12) Patent Application Publication
(10) Pub. No.: US 2026/0108948 A1
(43) Pub. Date: Apr. 23, 2026

(54) Powder Conveying Apparatus, Machine Tool and Screw

(71) Applicant: DMG MORI CO., LTD., NARA (JP)

(72) Inventors: Takeshi OTAWA, NARA (JP); Keiichi YAMAZAKI, NARA (JP); Hiroyuki ISHIMOTO, NARA (JP); Shun YONEZAWA, NARA (JP); Mikihiro SUDO, NARA (JP)

(73) Assignee: DMG MORI CO., LTD., NARA (JP)

(21) Appl. No.: 19/309,339

(22) Filed: Aug. 25, 2025

(30) Foreign Application Priority Data
Oct. 22, 2024 (JP) 2024-185759

(51) Int. Cl. B22F 12/52; B33Y 30/00

(52) U.S. Cl. CPC B22F 12/52; B33Y 30/00

(57) ABSTRACT

The powder conveying apparatus includes: a screw which includes a first threaded portion and a second threaded portion provided with reverse threads with respect to that of the first threaded portion; and a housing which is provided with a first powder supply port, a second powder supply, and a powder discharge port disposed between the first powder supply port and the second powder supply port. The first threaded portion includes a first intermittently threaded region which is disposed opposite to the powder discharge port with the first powder supply port interposed therebetween, and in which threads constituting the first threaded portion intermittently extend. The second threaded portion includes a second intermittently threaded region which is disposed opposite to the powder discharge port with the second powder supply port interposed therebetween, and in which threads constituting the second threaded portion intermittently extend.

### CROSS REFERENCE TO RELATED APPLICATIONS

This non-provisional application is based on Japanese Patent Application No. 2024-185759 filed on Oct. 22, 2024 with the Japan Patent Office, the entire contents of which are hereby incorporated by reference.

### BACKGROUND OF THE INVENTION

### Field of the Invention

The present invention relates to a powder conveying apparatus, a machine tool, and a screw.

### Description of the Background Art

For example, Japanese Patent Laying-Open No. 2024-3370 discloses a three-dimensional additive manufacturing apparatus based on a powder bed fusion method. The three-dimensional additive manufacturing apparatus includes a powder supply device for supplying powder to an upper surface of a table disposed inside a chamber.

### SUMMARY OF THE INVENTION

As disclosed in Japanese Patent Laying-Open No. 2024-3370, a powder conveying apparatus is used to convey powder in an additive manufacturing machine or the like that performs additive manufacturing on a workpiece. Such a powder conveying apparatus is configured to rotate a screw so as to convey powder in the axial direction of the screw.

However, when the powder to be supplied to the screw is conveyed to a path different from the original convey path, a phenomenon may occur in which the powder may be retained in a gap between the screw and an inner wall of a housing that houses the screw. In this case, as the screw rotates, the powder retained in the gap may be compressed and welded (cold-welded), which may interfere with the rotation of the screw. Such a concern becomes remarkable when the powder to be conveyed has a low melting point, such as aluminum.

An object of the present invention is to provide a powder conveying apparatus, a machine tool, and a screw capable of preventing powder to be conveyed from being cold-welded.

A powder conveying apparatus according to one aspect of the present invention includes: a screw that includes a first threaded portion and a second threaded portion provided with reverse threads with respect to that of the first threaded portion, and is configured to convey powder by rotating about a rotation axis; and a housing that is provided with a first powder supply port for supplying the powder toward the first threaded portion, a second powder supply port for supplying the powder toward the second threaded portion, and a powder discharge port disposed between the first powder supply port and the second powder supply port in an axial direction of the rotation axis for discharging the powder, and is configured to house the screw. The first threaded portion includes a first intermittently threaded region which is disposed opposite to the powder discharge port with the first powder supply port interposed therebetween in the axial direction of the rotation axis, and in which threads constituting the first threaded portion intermittently extend around the rotation axis. The second threaded portion includes a second intermittently threaded region which is disposed opposite to the powder discharge port with the second powder supply port interposed therebetween in the axial direction of the rotation axis, and in which threads constituting the second threaded portion intermittently extend around the rotation axis.

A machine tool according to the present invention includes the above-described powder conveying apparatus and a machine body that processes the powder conveyed by the powder conveying apparatus.

A screw according to the present invention is configured to convey powder by rotating about a rotation axis. The screw includes a first threaded portion, and a second threaded portion that is provided with reverse threads with respect to that of the first threaded portion and is disposed at a position shifted from the first threaded portion in an axial direction of the rotation axis. The first threaded portion includes: a first threaded region in which threads constituting the first threaded portion continuously extend around the rotation axis; and a second threaded region which is disposed opposite to the second threaded portion with the first threaded region interposed therebetween in the axial direction of the rotation axis and in which threads constituting the first threaded portion intermittently extend around the rotation axis. The second threaded portion includes: a third threaded region in which threads constituting the second threaded portion continuously extend around the rotation axis; and a fourth threaded region which is disposed opposite to the first threaded portion with the third threaded region interposed therebetween in the axial direction of the rotation axis and in which threads constituting the second threaded portion intermittently extend around the rotation axis.

A powder conveying apparatus according to another aspect of the present invention includes a screw configured to convey powder by rotating about a rotation axis, and a housing configured to house the screw. The housing is provided with a powder supply port for supplying powder toward the screw, and a powder discharge port that is disposed at a position shifted from the powder supply port in the axial direction of the rotation axis for discharging the powder conveyed by the screw. The housing includes an inner wall that faces the screw in a radial direction of the rotation axis and is formed with the powder supply port. The housing is further provided with a recess which is disposed opposite to the powder discharge port with the powder supply port interposed therebetween in the axial direction of the rotation axis, and has a shape recessed outward from the inner wall in the radial direction of the rotation axis.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view illustrating a machine tool equipped with a powder conveying apparatus according to a first embodiment of the present invention.

FIG. 2 is a front view illustrating the powder conveying apparatus in FIG. 1.

FIG. 3 is a cross-sectional view partially illustrating the powder conveying apparatus in FIG. 2.

FIG. 4 is a view illustrating a screw in FIG. 3.

FIG. 5 is a cross-sectional view illustrating the powder conveying apparatus as viewed from the arrow direction of line V-V in FIG. 2.

FIG. 6 is a cross-sectional view illustrating the powder conveying apparatus in FIG. 3.

FIG. 7 is a cross-sectional view illustrating a powder conveying apparatus according to a second embodiment of the present invention.

### DESCRIPTION OF THE PREFERRED EMBODIMENTS

Embodiments of the present invention will be described with reference to the drawings. It should be noted that the same or corresponding members in the drawings will be denoted by the same reference numerals, and the description thereof will not be repeated.

### First Embodiment

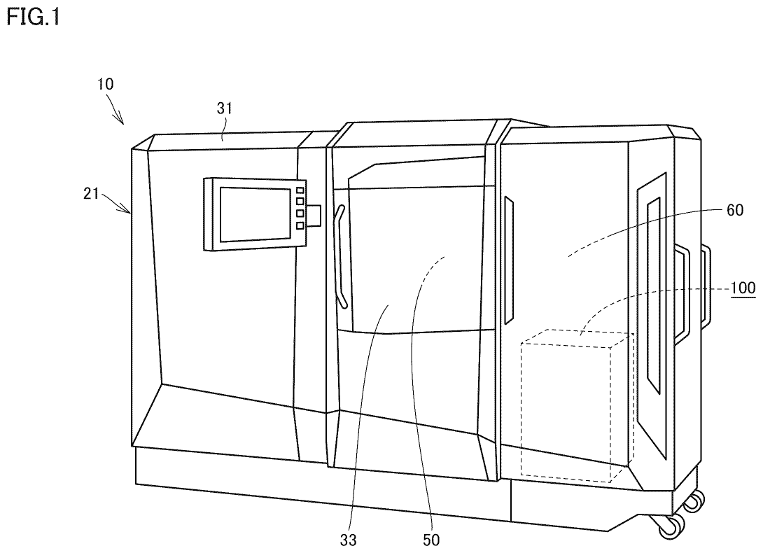

FIG. 1 is a perspective view illustrating a machine tool equipped with a powder conveying apparatus according to a first embodiment of the present invention. With reference to FIG. 1, a powder conveying apparatus 100 according to the present embodiment is used in a machine tool 10.

Machine tool 10 is an additive manufacturing machine capable of performing additive manufacturing (AM). Machine tool 10 adopts a powder bed fusion method in which metal powder is spread on a table and a laser beam is irradiated on the spread powder to melt and solidify a desired portion of the spread powder.

Machine tool 10 includes a machine body 21 and a powder conveying apparatus 100. Machine body 21 is a main body of machine tool 10, and performs additive manufacturing.

Machine body 21 includes a cover body 31, a door 33, a processing chamber 50, a table (not shown) which is disposed in processing chamber 50 and on which powder is spread, and a laser irradiation device (not shown) which irradiates the powder spread on the table with a laser.

Cover body 31 covers processing chamber 50 and forms an outer appearance of machine tool 10. Processing chamber 50 and door 33 define a space in which additive manufacturing is performed. In order to prevent the powder from being oxidized, processing chamber 50 is filled with an inert gas such as argon.

Door 33 is attached to processing chamber 50 so as to be rotatable about a rotation axis that extends in the vertical direction. By rotating door 33, processing chamber 50 is blocked from the external space or opened to the external space.

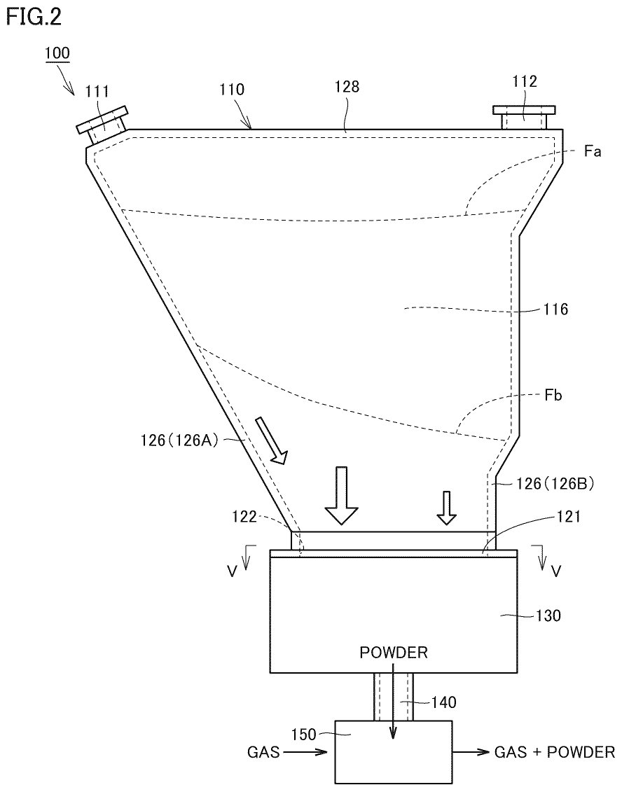

FIG. 2 is a front view illustrating the powder conveying apparatus in FIG. 1. With reference to FIGS. 1 and 2, powder conveying apparatus 100 conveys powder to be used for additive manufacturing in machine body 21. Powder conveying apparatus 100 is disposed outside processing chamber 50. Cover body 31 defines a housing space 60. Powder conveying apparatus 100 is housed in housing space 60.

Powder conveying apparatus 100 includes a tank 110, a powder conveying unit 130, a pipe 140, and a powder delivery unit 150.

Tank 110 stores powder. Tank 110 has a bottom surface 121, a side surface 126, and an upper surface 128. Bottom surface 121 is provided with an opening 122. Side surface 126 rises from the opening edge of opening 122 of bottom surface 121. A storage space 116 for storing the powder is formed at a position surrounded by side surface 126 above an opening plane formed by opening 122 of bottom surface 121. Upper surface 128 faces the opening plane formed by opening 122 in the vertical direction. Upper surface 128 is connected to an upper end of side surface 126.

Tank 110 is provided with a powder recovery port 111 and a powder replenishment port 112. Powder recovery port 111 and powder replenishment port 112 are opened to upper surface 128 and communicate with storage space 116. The powder not used for the additive manufacturing in machine body 21 is conveyed from processing chamber 50 to powder conveying apparatus 100, and is recovered into storage space 116 through powder recovery port 111. When the amount of powder stored in storage space 116 is insufficient, new powder is replenished to storage space 116 through powder replenishment port 112.

Powder conveying unit 130 conveys the powder from tank 110. Powder conveying unit 130 conveys the powder stored in tank 110 to pipe 140 and powder delivery unit 150, which will be described later. Powder conveying unit 130 is disposed below tank 110. Bottom surface 121 of tank 110 is connected to a top surface of powder conveying unit 130.

The powder from powder conveying unit 130 flows through pipe 140. The powder from powder conveying unit 130 flows through pipe 140 to powder delivery unit 150. Pipe 140 is formed of a pipe member and extends in the vertical direction. Pipe 140 extends between powder conveying unit 130 and powder delivery unit 150. An upper end of pipe 140 is connected to a bottom surface of powder conveying unit 130. A lower end of pipe 140 is connected to powder delivery unit 150.

Powder delivery unit 150 mixes the powder from pipe 140 with a gas and delivers the powder mixed with the gas. Powder delivery unit 150 mixes the powder from pipe 140 with the gas and delivers the powder mixed with the gas to processing chamber 50.

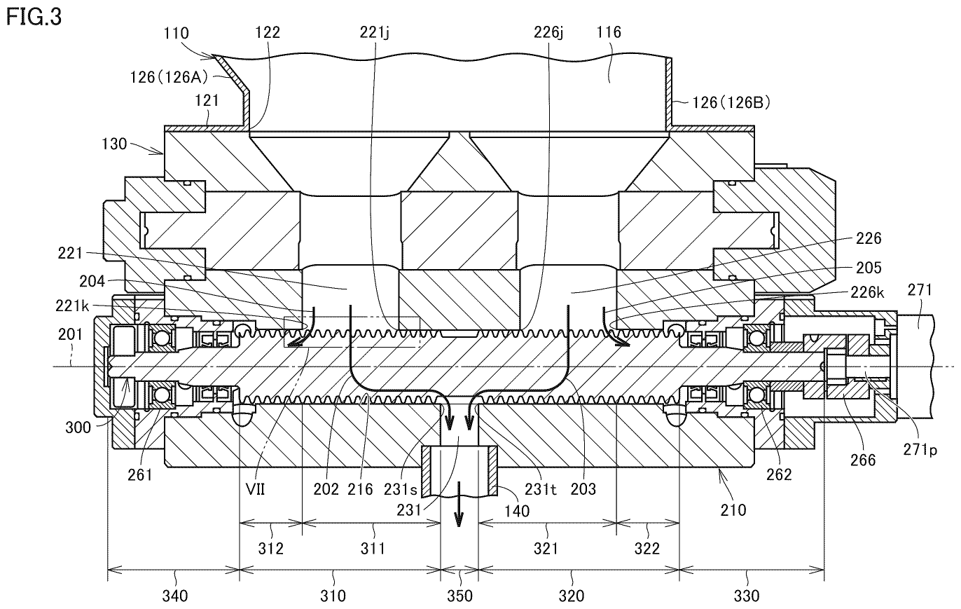

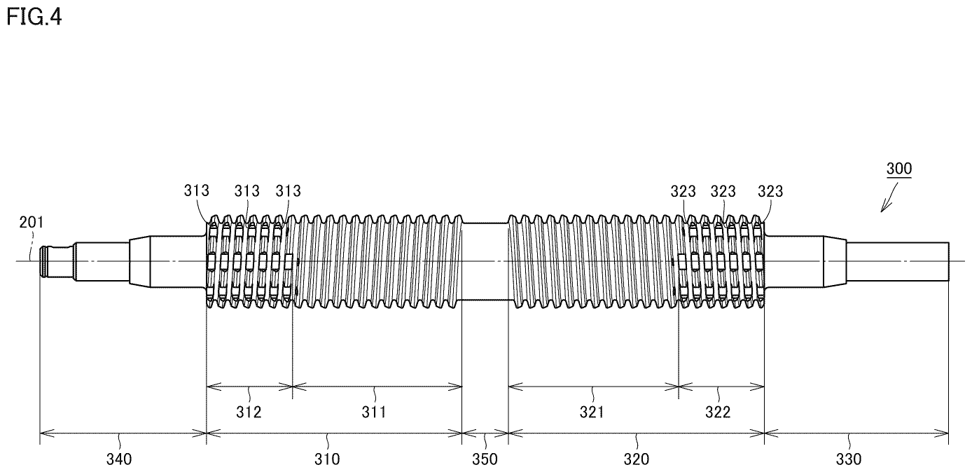

FIG. 3 is a cross-sectional view partially illustrating the powder conveying apparatus in FIG. 2. FIG. 4 is a view illustrating a screw in FIG. 3. With reference to FIGS. 3 and 4, powder conveying apparatus 100 (powder conveying unit 130) includes a screw 300, a housing 210, a first bearing 261, and a second bearing 262.

Screw 300 extends around a rotation axis 201. Rotation axis 201 is a virtual straight line corresponding to a central rotation axis of screw 300. Generally, screw 300 is a shaft body that rotates about rotation axis 201. Screw 300 is made of, for example, steel.

Housing 210 houses screw 300. Housing 210 is a cylindrical body that extends along rotation axis 201. Housing 210 is made of, for example, aluminum. Housing 210 has an inner wall 216. Inner wall 216 faces screw 300 with a gap therebetween in the radial direction of rotation axis 201. The size of the gap may be in a range of 0.1 mm or more and 1.0 mm or less in diameter or in a range of 0.2 mm or more and 0.5 mm or less in diameter.

Screw 300 is supported in such a manner that rotation axis 201 extends in the horizontal direction. Tank 110 is disposed above screw 300. Pipe 140 is disposed below screw 300. Powder delivery unit 150 is disposed below screw 300.

First bearing 261 and second bearing 262 are spaced apart from each other in the axial direction of rotation axis 201. Screw 300 is supported by first bearing 261 and second bearing 262 so as to be rotatable about rotation axis 201.

Powder conveying apparatus 100 (powder conveying unit 130) further includes a motor 271. An output shaft 271p of motor 271 is connected to screw 300 via a coupling 266. Screw 300 rotates about rotation axis 201 when receiving a rotation force from motor 271.

Screw 300 can convey the powder by rotating around rotation axis 201. Screw 300 can convey the powder in the axial direction of rotation axis 201 while rotating around rotation axis 201.

Screw 300 has a first shaft end portion 340, a first threaded portion 310, a shaft intermediate portion 350, a second threaded portion 320, and a second shaft end portion 330. First shaft end portion 340, first threaded portion 310, shaft intermediate portion 350, second threaded portion 320, and second shaft end portion 330 are arranged in the axial direction of rotation axis 201 in the order described above.

First threaded portion 310 extends around rotation axis 201. Second threaded portion 320 extends around rotation axis 201. Second threaded portion 320 is disposed at a position shifted from first threaded portion 310 in the axial direction of rotation axis 201. Each of first threaded portion 310 and the second threaded portion is a shaft body (cylindrical body) that rotates about rotation axis 201, and is provided with threads spirally extending around rotation axis 201 along the outer peripheral surface of the shaft body. Second threaded portion 320 is provided with reverse threads with respect to that of first threaded portion 310. First threaded portion 310 is provided with one of right-handed threads and left-handed threads, and second threaded portion 320 is provided with the other of right-handed threads and left-handed threads.

Shaft intermediate portion 350 is a shaft body that rotates about rotation axis 201. Shaft intermediate portion 350 is provided between first threaded portion 310 and second threaded portion 320 in the axial direction of rotation axis 201. The diameter of shaft intermediate portion 350 is larger than both the diameter of first shaft end portion 340 and the diameter of second shaft end portion 330.

First shaft end portion 340 is a shaft body that rotates about rotation axis 201. First shaft end portion 340 is provided at one end of screw 300 in the axial direction of rotation axis 201. First threaded portion 310 is provided between first shaft end portion 340 and shaft intermediate portion 350 in the axial direction of rotation axis 201. First bearing 261 is fitted on the outer peripheral surface of first shaft end portion 340.

Second shaft end portion 330 is a shaft body that rotates about rotation axis 201. Second shaft end portion 330 is provided at the other end of screw 300 in the axial direction of rotation axis 201. Second threaded portion 320 is provided between shaft intermediate portion 350 and second shaft end portion 330 in the axial direction of rotation axis 201. Second bearing 262 is fitted on the outer peripheral surface of second shaft end portion 330. Output shaft 271p of motor 271 is connected to second shaft end portion 330 via coupling 266.

First threaded portion 310 includes a first threaded region 311 and a second threaded region 312. First threaded region 311 and second threaded region 312 are arranged side by side in the axial direction of rotation axis 201. First threaded region 311 is provided between second threaded region 312 and shaft intermediate portion 350 in the axial direction of rotation axis 201. First threaded region 311 is provided between second threaded region 312 and second threaded portion 320 in the axial direction of rotation axis 201.

Second threaded region 312 is provided between first shaft end portion 340 and first threaded region 311 in the axial direction of rotation axis 201. Second threaded region 312 is disposed opposite to second threaded portion 320 with first threaded region 311 interposed therebetween in the axial direction of rotation axis 201. The length of first threaded region 311 in the axial direction of rotation axis 201 is greater than the length of second threaded region 312 in the axial direction of rotation axis 201.

In first threaded region 311, threads constituting first threaded portion 310 continuously extend around rotation axis 201. In second threaded region 312, threads constituting first threaded portion 310 intermittently extend around rotation axis 201. Second threaded region 312 is provided with a plurality of first notches 313. The plurality of first notches 313 cut out the threads constituting first threaded portion 310 at positions spaced apart from each other in the circumferential direction of rotation axis 201.

The height of the thread at the position where the first notch 313 is provided may be zero, or may be smaller than the height of the thread at the position where the first notch 313 is not provided. The plurality of first notches 313 may be provided at equal intervals (for example, at an interval of 60 degrees) in the circumferential direction of rotation axis 201. The plurality of first notches 313 may be provided at irregular intervals in the circumferential direction of rotation axis 201. As illustrated in FIG. 4, the interval between the plurality of first notches 313 may be determined in such a manner that the positions where the plurality of first notches 313 are provided are aligned with each other in the axial direction of rotation axis 201.

Second threaded portion 320 includes a third threaded region 321 and a fourth threaded region 322. Third threaded region 321 and fourth threaded region 322 are arranged side by side in the axial direction of rotation axis 201. Third threaded region 321 is provided between fourth threaded region 322 and shaft intermediate portion 350 in the axial direction of rotation axis 201. Third threaded region 321 is provided between fourth threaded region 322 and first threaded portion 310 in the axial direction of rotation axis 201.

Fourth threaded region 322 is provided between second shaft end portion 330 and third threaded region 321 in the axial direction of rotation axis 201. Fourth threaded region 322 is disposed opposite to first threaded portion 310 with third threaded region 321 interposed therebetween in the axial direction of rotation axis 201. The length of third threaded region 321 in the axial direction of rotation axis 201 is greater than the length of fourth threaded region 322 in the axial direction of rotation axis 201.

In third threaded region 321, the threads constituting second threaded portion 320 continuously extend around rotation axis 201. In fourth threaded region 322, the threads constituting second threaded portion 320 intermittently extend around rotation axis 201. Fourth threaded region 322 is provided with a plurality of second notches 323. The plurality of second notches 323 cut out threads constituting second threaded portion 320 at positions spaced apart from each other in the circumferential direction of rotation axis 201. The plurality of second notches 323 are provided in the same manner as the plurality of first notches 313.

First threaded region 311 and second threaded region 312, and third threaded region 321 and fourth threaded region 322 may be provided symmetrically with respect to shaft intermediate portion 350 (a powder discharge port 231 to be described later).

As illustrated in FIG. 3, housing 210 is provided with a first powder supply port 221, a second powder supply port 226, and a powder discharge port 231. First powder supply port 221, second powder supply port 226, and powder discharge port 231 are opened to inner wall 216.

First powder supply port 221 and second powder supply port 226 are opened to inner wall 216 above powder discharge port 231. Second powder supply port 226 is disposed at a position shifted from first powder supply port 221 in the axial direction of rotation axis 201. Powder discharge port 231 is provided between first powder supply port 221 and second powder supply port 226 in the axial direction of rotation axis 201. First powder supply port 221 and second powder supply port 226 may be provided symmetrically with respect to powder discharge port 231.

First powder supply port 221 and second powder supply port 226 communicate with storage space 116 via opening 122. Opening 122 is provided directly above first powder supply port 221 and second powder supply port 226. Powder discharge port 231 communicates with pipe 140.

First powder supply port 221 is opened to inner wall 216 so as to face first threaded portion 310. First powder supply port 221 defines a first opening edge 221j and a second opening edge 221k on inner wall 216. First opening edge 221j is closest to powder discharge port 231 in the axial direction of rotation axis 201 among the opening edges formed by first powder supply port 221 on inner wall 216. Second opening edge 221k is farthest from powder discharge port 231 in the axial direction of rotation axis 201 among the opening edges formed by first powder supply port 221 on inner wall 216.

Second powder supply port 226 is opened to inner wall 216 so as to face second threaded portion 320. Second powder supply port 226 defines a third opening edge 226j and a fourth opening edge 226k on inner wall 216. Third opening edge 226j is closest to powder discharge port 231 in the axial direction of rotation axis 201 among the opening edges formed by second powder supply port 226 on inner wall 216. Fourth opening edge 226k is farthest from powder discharge port 231 in the axial direction of rotation axis 201 among the opening edges formed by second powder supply port 226 on inner wall 216.

Powder discharge port 231 is opened to inner wall 216 so as to face shaft intermediate portion 350. Powder discharge port 231 defines a fifth opening edge 231s and a sixth opening edge 231t on inner wall 216. Fifth opening edge 231s is closest to first powder supply port 221 in the axial direction of rotation axis 201 among the opening edges formed by powder discharge port 231 on inner wall 216. Sixth opening edge 231t is closest to second powder supply port 226 in the axial direction of rotation axis 201 among the opening edges formed by powder discharge port 231 on inner wall 216.

First threaded region 311 is provided between first powder supply port 221 and powder discharge port 231 in the axial direction of rotation axis 201. First threaded region 311 is provided in a range from fifth opening edge 231s to second opening edge 221k via first opening edge 221j in the axial direction of rotation axis 201. Second threaded region 312 is disposed opposite to powder discharge port 231 with first powder supply port 221 interposed therebetween in the axial direction of rotation axis 201. Second opening edge 221k forms a boundary between first threaded region 311 and second threaded region 312 in the axial direction of rotation axis 201.

The boundary between first threaded region 311 and second threaded region 312 in the axial direction of rotation axis 201 may be shifted from second opening edge 221k toward first opening edge 221j. In this case, the boundary between first threaded region 311 and second threaded region 312 in the axial direction of rotation axis 201 is preferably closer to second opening edge 221k than first opening edge 221j. The shift amount of the boundary between first threaded region 311 and second threaded region 312 from second opening edge 221k may be 5 mm or less, 3 mm or less, or 1 mm or less.

The boundary between first threaded region 311 and second threaded region 312 in the axial direction of rotation axis 201 may be shifted from second opening edge 221k toward first shaft end portion 340. In this case, the shift amount of the boundary between first threaded region 311 and second threaded region 312 from second opening edge 221k may be 1 mm or less, or may be 0.5 mm or less. The shift amount of the boundary between first threaded region 311 and second threaded region 312 from second opening edge 221k may be equal to or less than the pitch of the threads constituting first threaded portion 310 or may be equal to or less than half the pitch of the threads constituting first threaded portion 310.

Third threaded region 321 is provided between second powder supply port 226 and powder discharge port 231 in the axial direction of rotation axis 201. Third threaded region 321 is provided in a range from sixth opening edge 231t to fourth opening edge 226k via third opening edge 226j in the axial direction of rotation axis 201. Fourth threaded region 322 is disposed opposite to powder discharge port 231 with second powder supply port 226 interposed therebetween in the axial direction of rotation axis 201. Fourth opening edge 226k forms a boundary between third threaded region 321 and fourth threaded region 322 in the axial direction of rotation axis 201.

The boundary between third threaded region 321 and fourth threaded region 322 in the axial direction of rotation axis 201 may be shifted from fourth opening edge 226k toward third opening edge 226j. In this case, the boundary between third threaded region 321 and fourth threaded region 322 in the axial direction of rotation axis 201 is preferably provided closer to fourth opening edge 226k than third opening edge 226j. The shift amount of the boundary between third threaded region 321 and fourth threaded region 322 from fourth opening edge 226k may be 5 mm or less, 3 mm or less, or 1 mm or less.

The boundary between third threaded region 321 and fourth threaded region 322 in the axial direction of rotation axis 201 may be shifted from fourth opening edge 226k toward second shaft end portion 330. In this case, the shift amount of the boundary between third threaded region 321 and fourth threaded region 322 from fourth opening edge 226k may be 1 mm or less, or may be 0.5 mm or less. The shift amount of the boundary between third threaded region 321 and fourth threaded region 322 from fourth opening edge 226k may be equal to or less than the pitch of the threads forming second threaded portion 320 or may be equal to or less than half the pitch of the threads constituting first threaded portion 310.

With reference to FIGS. 2 to 4, the powder stored in tank 110 enters first powder supply port 221 and second powder supply port 226 through opening 122 by gravity. The powder that has entered first powder supply port 221 is supplied to first threaded portion 310 that rotates about rotation axis 201.

The powder is conveyed from first powder supply port 221 toward powder discharge port 231 (the movement of the powder indicated by an arrow 202 in FIG. 3) by first threaded region 311 in which the threads constituting first threaded portion 310 continuously extend around rotation axis 201. The powder that has entered second powder supply port 226 is supplied to second threaded portion 320 that rotates about rotation axis 201 and is provided with reverse threads with respect to that of first threaded portion 310. The powder is conveyed from second powder supply port 226 toward powder discharge port 231 (the movement of the powder indicated by an arrow 203 in FIG. 3) by third threaded region 321 in which the threads constituting second threaded portion 320 continuously extends around rotation axis 201. The powder conveyed by screw 300 is discharged toward pipe 140 through powder discharge port 231.

On the other hand, a part of the powder from first powder supply port 221 may enter a region opposite to powder discharge port 231 with first powder supply port 221 interposed therebetween in the axial direction of rotation axis 201 (the movement of the powder indicated by an arrow 204 in FIG. 3). Further, a part of the powder from second powder supply port 226 may enter a region opposite to powder discharge port 231 with second powder supply port 226 interposed therebetween in the axial direction of rotation axis 201 (the movement of the powder indicated by an arrow 205 in FIG. 3). In these regions, since the entire powder in housing 210 does not flow toward powder discharge port 231, a part of the powder is retained in the gap between screw 300 and inner wall 216 of housing 210. In this case, as screw 300 rotates, the retained powder may be compressed and welded (cold-welded), which may interfere with the rotation of screw 300.

To solve the above-mentioned problem, in the present embodiment, first threaded portion 310 includes a second threaded region 312 which is disposed opposite to powder discharge port 231 with first powder supply port 221 interposed therebetween in the axial direction of rotation axis 201, and in which the threads constituting first threaded portion 310 intermittently extend around rotation axis 201. With such a configuration, the powder retained in the gap between screw 300 and inner wall 216 of housing 210 can be released to the plurality of notches 313 on the threads provided in second threaded region 312, and the released powder can be conveyed toward first threaded region 311 by the threads provided in second threaded region 312.

In addition, second threaded portion 320 includes a fourth threaded region 322 which is disposed opposite to powder discharge port 231 with second powder supply port 226 interposed therebetween in the axial direction of rotation axis 201, and in which the threads constituting second threaded portion 320 intermittently extend around rotation axis 201. With such a configuration, the powder retained in the gap between screw 300 and inner wall 216 of housing 210 can be released to the plurality of notches 323 on the threads provided in fourth threaded region 322, and the released powder can be conveyed toward third threaded region 321 by the threads provided in fourth threaded region 322.

As described in the above, it is possible to prevent the powder from being cold-welded in the region opposite to powder discharge port 231 with first powder supply port 221 interposed therebetween in the axial direction of rotation axis 201 and in the region opposite to powder discharge port 231 with second powder supply port 226 interposed therebetween in the axial direction of rotation axis 201.

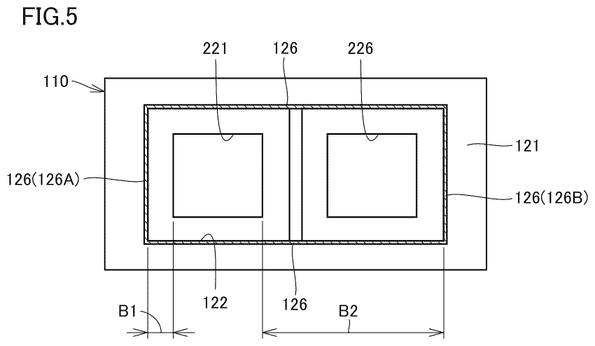

FIG. 5 is a cross-sectional view of the powder conveying apparatus taken along line V-V in FIG. 2. With reference to FIGS. 2, 3 and 5, side surface 126 of tank 110 includes a first side surface 126A and a second side surface 126B. Second side surface 126B faces first side surface 126A in the axial direction of rotation axis 201. Opening 122 is opened between first side surface 126A and second side surface 126B in the axial direction of rotation axis 201.

An angle formed by first side surface 126A with respect to the vertical direction is larger than an angle formed by second side surface 126B with respect to the vertical direction. First side surface 126A has a slope shape extending obliquely with respect to the vertical direction. The length of first side surface 126A in the axial direction of rotation axis 201 is greater than the length of second side surface 126B in the axial direction of rotation axis 201.

As illustrated in FIG. 5, in a top view, first powder supply port 221 is disposed closer to first side surface 126A than second side surface 126B in the axial direction of rotation axis 201. A distance B1 between first side surface 126A and first powder supply port 221 in the axial direction of rotation axis 201 is smaller than a distance B2 between first powder supply port 221 and second side surface 126B in the axial direction of rotation axis 201 (B1<B2).

In the top view, second powder supply port 226 is disposed closer to second side surface 126B than first side surface 126A in the axial direction of rotation axis 201. The distance between second side surface 126B and second powder supply port 226 in the axial direction of rotation axis 201 is smaller than the distance between first side surface 126A and second powder supply port 226 in the axial direction of rotation axis 201.

In FIG. 2, the amount of the powder stored in tank 110 is indicated by a dotted line Fa (when the storage amount is large) and a dotted line Fb (when the storage amount is small). When the storage amount of the powder is large, the height of the powder from bottom surface 121 is substantially uniform. On the other hand, when the storage amount of the powder is small, since the frictional force between the powder to be supplied to powder conveying unit 130 and first side surface 126A which has a slope shape is relatively larger, the height of the powder from bottom surface 121 becomes higher on the side of first side surface 126A and becomes lower on the side of second side surface 126B. In this case, since first powder supply port 221 is disposed closer to first side surface 126A than second side surface 126B in the axial direction of rotation axis 201, the amount of the powder to be supplied to screw 300 through first powder supply port 221 increases. Therefore, a phenomenon may easily occur in which a part of the powder from first powder supply port 221 falls into a region opposite to powder discharge port 231 with first powder supply port 221 interposed therebetween in the axial direction of rotation axis 201.

From such a viewpoint, in powder conveying apparatus 100 according to the present embodiment, first threaded portion 310 may be provided with first threaded region 311 and second threaded region 312, and second threaded portion 320 may be provided with only third threaded region 321.

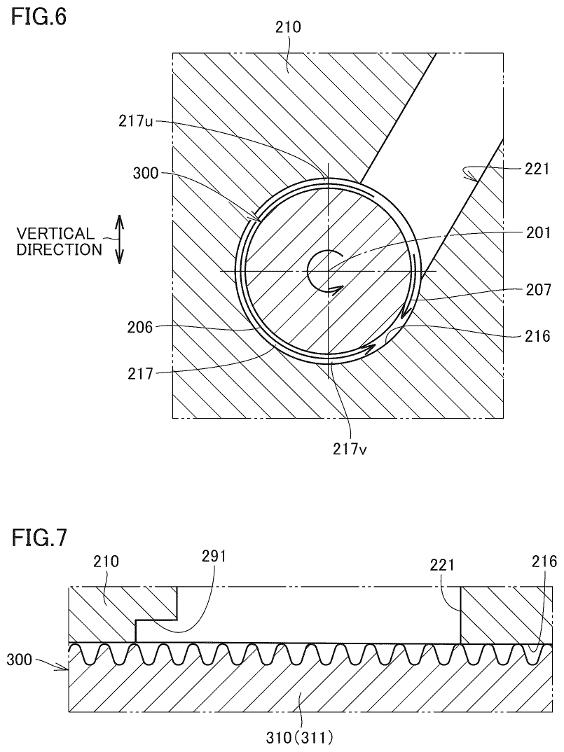

FIG. 6 is a cross-sectional view illustrating the powder conveying apparatus in FIG. 3. FIG. 6 illustrates a cross section of housing 210 and screw 300 taken along a plane perpendicular to rotation axis 201.

With reference to FIGS. 3 and 6, housing 210 is formed with a circular opening surface surrounded by inner wall 216. Screw 300 is disposed concentrically with respect to the circular opening surface formed in housing 210. First powder supply port 221 is opened to inner wall 216 in the vicinity of a top portion 217u of a gap 217. The rotation direction of screw 300 is in the counterclockwise direction in FIG. 6.

In this case, the path of the powder to be supplied to screw 300 from first powder supply port 221 includes a path (indicated by an arrow 207 in FIG. 6) in which the powder directly falls from first powder supply port 221 to a bottom portion 217v of the gap 217 and a path (indicated by an arrow 206 in FIG. 6) in which the powder is conveyed to the bottom portion 217v of the gap 217 via the top portion 217u of the gap 217 by the rotation of screw 300.

The configuration of powder conveying apparatus 100, machine tool 10 and screw 300 according to the first embodiment of the present invention described above will be summarized. Powder conveying apparatus 100 according to the present embodiment includes a screw 300 that includes a first threaded portion 310 and is configured to convey powder by rotating about a rotation axis 201, and a housing 210 that houses screw 300. Housing 210 is provided with a first powder supply port 221 for supplying the powder toward first threaded portion 310, and a powder discharge port 231 disposed at a position shifted from first powder supply port 221 in the axial direction of rotation axis 201 for discharging the powder conveyed by screw 300. First threaded portion 310 includes a first threaded region 311 which is provided between first powder supply port 221 and powder discharge port 231 in the axial direction of rotation axis 201 and in which threads constituting first threaded portion 310 continuously extend around rotation axis 201, and a second threaded region 312 which is disposed opposite to powder discharge port 231 with first powder supply port 221 interposed therebetween in the axial direction of rotation axis 201 and in which threads constituting first threaded portion 310 intermittently extend around rotation axis 201.

According to such a configuration, the powder supplied to first threaded portion 310 through first powder supply port 221 can be conveyed toward powder discharge port 231 by first threaded region 311 by the rotation of screw 300. In addition, the powder that has entered the region opposite to powder discharge port 231 with first powder supply port 221 interposed therebetween in the axial direction of rotation axis 201 can be released to second threaded region 312 in which the threads constituting first threaded portion 310 intermittently extend around rotation axis 201. Accordingly, it is possible to prevent the powder supplied through first powder supply port 221 from being cold-welded.

In addition, screw 300 further includes a second threaded portion 320 that is provided with reverse threads with respect to that of first threaded portion 310. Housing 210 is further provided with a second powder supply port 226 which is disposed opposite to first powder supply port 221 with powder discharge port 231 interposed therebetween in the axial direction of rotation axis 201 and is configured to supply powder toward second threaded portion 320.

According to such a configuration, the powder supplied to second threaded portion 320 through second powder supply port 226 can be conveyed toward powder discharge port 231 by the rotation of screw 300.

In addition, second threaded portion 320 includes a third threaded region 321 which is provided between second powder supply port 226 and powder discharge port 231 in the axial direction of rotation axis 201 and in which the threads constituting second threaded portion 320 continuously extend around rotation axis 201, and a fourth threaded region 322 which is disposed opposite to powder discharge port 231 with second powder supply port 226 interposed therebetween in the axial direction of rotation axis 201 and in which the threads constituting second threaded portion 320 intermittently extend around rotation axis 201.

According to such a configuration, the powder that has entered the region opposite to powder discharge port 231 with second powder supply port 226 interposed therebetween in the axial direction of rotation axis 201 can be released to fourth threaded region 322 in which the threads constituting second threaded portion 320 intermittently extend around rotation axis 201. Accordingly, it is possible to prevent the powder supplied through second powder supply port 226 from being cold-welded.

Powder conveying apparatus 100 further includes a tank 110 that is disposed above screw 300 and is configured to store the powder to be supplied to first powder supply port 221, a powder conveying unit 130 that includes screw 300 and is configured to convey the powder from tank 110, a pipe 140 that is disposed below screw 300 and is configured to transfer the powder from powder discharge port 231, and a powder delivery unit 150 that is disposed below pipe 140 and is configured to mix the powder from pipe 140 with a gas and deliver the powder mixed with the gas.

According to such a configuration, the powder can be conveyed in the order of tank 110, powder conveying unit 130, pipe 140, and powder delivery unit 150 by gravity acting on the powder and the rotation of screw 300.

Powder conveying apparatus 100 according to the present embodiment includes: a screw 300 that includes a first threaded portion 310 and a second threaded portion 320 provided with reverse threads with respect to that of first threaded portion 310, and is configured to convey powder by rotating about a rotation axis 201; and a housing 210 that is provided with a first powder supply port 221 for supplying the powder toward first threaded portion 310, a second powder supply port 226 for supplying the powder toward second threaded portion 320, and a powder discharge port 231 disposed between first powder supply port 221 and second powder supply port 226 in an axial direction of rotation axis 201 for discharging the powder, and is configured to house screw 300. First threaded portion 310 includes a first intermittently threaded region 312 which is disposed opposite to powder discharge port 231 with first powder supply port 221 interposed therebetween in the axial direction of rotation axis 201, and in which threads constituting first threaded portion 310 intermittently extend around rotation axis 201. Second threaded portion 320 includes a second intermittently threaded region 322 which is disposed opposite to powder discharge port 231 with second powder supply port 226 interposed therebetween in the axial direction of rotation axis 201, and in which threads constituting second threaded portion 320 intermittently extend around rotation axis 201.

Machine tool 10 includes powder conveying apparatus 100 and a machine body 21 that performs additive manufacturing of a workpiece using the powder conveyed by powder conveying apparatus 100.

According to such a configuration, it is possible to prevent the powder used for additive manufacturing of a workpiece from being cold-welded.

Screw 300 according to the present embodiment can convey powder by rotating around rotation axis 201. Screw 300 includes a first threaded portion 310 and a second threaded portion 320 that is provided with reverse threads with respect to that of first threaded portion 310 and is disposed at a position shifted from first threaded portion 310 in the axial direction of rotation axis 201. First threaded portion 310 includes a first threaded region (first continuously threaded region) 311 in which threads constituting first threaded portion 310 continuously extend around rotation axis 201, and a second threaded region (first intermittently threaded region) 312 which is disposed opposite to second threaded portion 320 with the first threaded region (first continuously threaded region) 311 interposed therebetween in the axial direction of rotation axis 201 and in which threads constituting first threaded portion 310 intermittently extend around rotation axis 201. Second threaded portion 320 includes a third threaded region (second continuously threaded region) 321 in which threads constituting second threaded portion 320 continuously extend around rotation axis 201, and a fourth threaded region (second intermittently threaded region) 322 which is disposed opposite to first threaded portion 310 with the third threaded region (second continuously threaded region) 321 interposed therebetween in the axial direction of rotation axis 201 and in which threads constituting second threaded portion 320 intermittently extend around rotation axis 201.

According to such a configuration, by rotating screw 300 in a predetermined direction around rotation axis 201, the powder supplied to first threaded portion 310 can be conveyed toward second threaded portion 320 in the axial direction of rotation axis 201 through first threaded region 311, and the powder supplied to second threaded portion 320 can be conveyed toward first threaded portion 310 in the axial direction of rotation axis 201 through third threaded region 321.

Further, if the powder has entered the region opposite to second threaded portion 320 with first threaded region 311 interposed therebetween in the axial direction of rotation axis 201, the powder can be released to second threaded region 312 in which the threads constituting first threaded portion 310 intermittently extend around rotation axis 201. If the powder has entered the region opposite to first threaded portion 310 with third threaded region 321 interposed therebetween in the axial direction of rotation axis 201, the powder can be released to fourth threaded region 322 in which the threads constituting second threaded portion 320 intermittently extend around rotation axis 201. Thus, it is possible to prevent the powder from being cold-welded.

The powder conveying apparatus and the screw of the present invention may be used in an additive manufacturing machine (3D printer) based on any method other than the powder bed fusion method. The present invention is suitably used for conveying metal powder such as aluminum having a low melting point, but may be used for conveying metal powder having a high melting point such as stainless steel and Inconel (registered trademark) alloy. The present invention may be used for conveying resin powder.

### Second Embodiment

FIG. 7 is a cross-sectional view illustrating a powder conveying apparatus according to a second embodiment of the present invention. FIG. 7 illustrates a part of the powder conveying apparatus corresponding to the part surrounded by a two-dot chain line VII in FIG. 3. The powder conveying apparatus according to the present embodiment has basically the same structure as powder conveying apparatus 100 according to the first embodiment. Hereinafter, the description of the same structure will not be repeated.

With reference to FIGS. 3 and 7, in the present embodiment, housing 210 is further provided with a recess 291. Recess 291 is continuous with first powder supply port 221 in the axial direction of rotation axis 201. Recess 291 is disposed opposite to powder discharge port 231 with first powder supply port 221 interposed therebetween in the axial direction of rotation axis 201. Recess 291 has a shape recessed outward from inner wall 216 in the radial direction of rotation axis 201.

When the powder from first powder supply port 221 enters the region opposite to powder discharge port 231 with first powder supply port 221 interposed therebetween in the axial direction of rotation axis 201, recess 291 functions to release the powder (functions as the first notches 313 in second threaded region 312 described in the first embodiment).

The depth of recess 291 from inner wall 216 may be greater than the gap between inner wall 216 and screw 300. The depth of recess 291 from inner wall 216 may be greater than the height of the threads (the length between the top and bottom of the threads in the radial direction of rotation axis 201) constituting first threaded portion 310. The depth of recess 291 from inner wall 216 may be in the range of 1 mm or more and 20 mm or less, or may be in the range of 3 mm or more and 10 mm or less.

The width of recess 291 in the axial direction of rotation axis 201 may be greater than the pitch of the threads constituting first threaded portion 310. The width of recess 291 in the axial direction of rotation axis 201 may be greater than two times the pitch of the threads constituting first threaded portion 310, or may be greater than three times the pitch of the threads constituting first threaded portion 310.

In addition, second powder supply port 226 may be provided with a recess which is the same as recess 291. The recess may be disposed opposite to powder discharge port 231 with second powder supply port 226 interposed therebetween in the axial direction of rotation axis 201.

In the present embodiment, first threaded portion 310 of screw 300 may include only first threaded region 311, and second threaded portion 320 of screw 300 may include only third threaded region 321.

To summarize the configuration of the powder conveying apparatus according to the second embodiment of the present invention described above, the powder conveying apparatus according to the present embodiment includes a screw 300 configured to convey the powder by rotating around rotation axis 201, and a housing 210 that houses screw 300. Housing 210 is provided with a first powder supply port 221 as a powder supply port for supplying the powder toward screw 300, and a powder discharge port 231 which is disposed at a position shifted from first powder supply port 221 in the axial direction of rotation axis 201 for discharging the powder conveyed by screw 300. Housing 210 includes an inner wall 216 that faces screw 300 in the radial direction of rotation axis 201 and is opened to first powder supply port 221. Housing 210 is further provided with a recess 291 which is disposed opposite to powder discharge port 231 with first powder supply port 221 interposed therebetween in the axial direction of rotation axis 201 and has a shape recessed outward from inner wall 216 in the radial direction of rotation axis 201.

According to such a configuration, the powder that has entered the region opposite to powder discharge port 231 with first powder supply port 221 interposed therebetween in the axial direction of rotation axis 201 can be released to recess 291 which has a shape recessed outward from inner wall 216 in the radial direction of rotation axis 201. Accordingly, it is possible to prevent the powder supplied through first powder supply port 221 from being cold-welded.

Although the embodiments of the present invention have been described, it should be understood that the embodiments disclosed herein have been presented for the purpose of illustration and description but not limited in all aspects. It is intended that the scope of the present invention is not limited to the description above but defined by the scope of the claims and encompasses all modifications equivalent in meaning and scope to the claims.

What is claimed is:

1. A powder conveying apparatus comprising:
a screw that includes a first threaded portion and a second threaded portion provided with reverse threads with respect to that of the first threaded portion, and is configured to convey powder by rotating about a rotation axis; and
a housing that is provided with a first powder supply port for supplying the powder toward the first threaded portion, a second powder supply port for supplying the powder toward the second threaded portion, and a powder discharge port disposed between the first powder supply port and the second powder supply port in an axial direction of the rotation axis for discharging the powder, and is configured to house the screw,
the first threaded portion includes a first intermittently threaded region which is disposed opposite to the powder discharge port with the first powder supply port interposed therebetween in the axial direction of the rotation axis, and in which threads constituting the first threaded portion intermittently extend around the rotation axis, and
the second threaded portion includes a second intermittently threaded region which is disposed opposite to the powder discharge port with the second powder supply port interposed therebetween in the axial direction of the rotation axis, and in which threads constituting the second threaded portion intermittently extend around the rotation axis.

2. The powder conveying apparatus according to claim 1, further comprising:
a tank that includes a bottom surface which is provided with an opening directly above the housing and a side surface which rises from the bottom surface, and is configured to form a space for storing powder at a position surrounded by the side surface above the bottom surface,
the side surface includes a first side surface and a second side surface that faces the first side surface in the axial direction of the rotation axis,
an angle formed by the first side surface with respect to a vertical direction is larger than an angle formed by the second side surface with respect to the vertical direction, and
in a top view, the first powder supply port is disposed closer to the first side surface than the second side surface in the axial direction of the rotation axis.

3. The powder conveying apparatus according to claim 1, further comprising:
a tank that is disposed above the screw and is configured to store powder to be supplied to the first powder supply port;
a powder conveying unit that includes the screw and is configured to convey the powder from the tank;
a pipe that is disposed below the screw and is configured to transfer the powder from the powder discharge port; and
a powder delivery unit that is disposed below the pipe and is configured to mix the powder from the pipe with a gas and deliver the powder mixed with the gas.

4. A machine tool comprising:
the powder conveying apparatus according to claim 1; and
a machine body that processes the powder conveyed by the powder conveying apparatus.

5. A screw configured to convey powder by rotating about a rotation axis, the screw comprising:
a first threaded portion; and
a second threaded portion that is provided with reverse threads with respect to that of the first threaded portion and is disposed at a position shifted from the first threaded portion in an axial direction of the rotation axis,
the first threaded portion includes:
a first continuously threaded region in which threads constituting the first threaded portion continuously extend around the rotation axis; and
a first intermittently threaded region which is disposed opposite to the second threaded portion with the first continuously threaded region interposed therebetween in the axial direction of the rotation axis and in which threads constituting the first threaded portion intermittently extend around the rotation axis,
the second threaded portion includes:
a second continuously threaded region in which threads constituting the second threaded portion continuously extend around the rotation axis; and
a second intermittently threaded region which is disposed opposite to the first threaded portion with the second continuously threaded region interposed therebetween in the axial direction of the rotation axis and in which threads constituting the second threaded portion intermittently extend around the rotation axis.

6. A powder conveying apparatus comprising:
a screw configured to convey powder by rotating about a rotation axis; and
a housing configured to house the screw,
the housing is provided with a powder supply port for supplying powder toward the screw, and a powder discharge port that is disposed at a position shifted from the powder supply port in the axial direction of the rotation axis for discharging the powder conveyed by the screw,
the housing includes an inner wall that faces the screw in a radial direction of the rotation axis and is formed with the powder supply port,
the housing is further provided with a recess that is disposed opposite to the powder discharge port with the powder supply port interposed therebetween in the axial direction of the rotation axis, and has a shape recessed outward from the inner wall in the radial direction of the rotation axis.
